(19) United States
(12) Patent Application Publication
(10) Pub. No.: US 2008/0312363 A1
(43) Pub. Date: Dec. 18, 2008

(54) Method for Shaping Stabilizer Melts Into Pastilles, Shaped Bodies Produced Accordingly and the Use Thereof

(75) Inventor: Stefan Fokken, Biberbach (DE)

Correspondence Address: FISH & RICHARDSON P.C., P.O BOX 1022, Minneapolis, MN, 55440-1022, US

(73) Assignee: BAERLOCHER GMBH, Unterschleissheim (DE)

(21) Appl. No.: 11/815,282

(22) PCT Filed: Jan. 30, 2006
(86) PCT No.: PCT/EP06/00785

§ 371 Date: May 16, 2008

(30) Foreign Application Priority Data
Feb. 4, 2005 (DE) 10 2005 005 281.9

(51) Int. Cl. C08K 5/56

(52) U.S. Cl. 524/174; 524/175

(57) ABSTRACT

The invention relates to a method for manufacturing melts that contain CaO or Ca(OH)₂ or both, to melt-shaped bodies so produced and to the use of said melt-shaped bodies for stabilizing preferably halogen-containing polymers.

The present invention relates to a method for shaping Ca/Zn melts into pastilles, to shaped bodies produced accordingly and to the use thereof.

As is known, halogen-containing plastics have a tendency to undergo unwanted decomposition and degradation reactions when exposed to elevated temperatures during processing or over long-term service. When halogenated polymers, in particular PVC, degrade, hydrochloric acid is formed which is eliminated from the polymer strand, so giving rise to a discoloured, unsaturated plastic comprising colour-imparting polyene sequences.

One particularly problematic factor is that halogen-containing polymers only exhibit the rheological conditions necessary for processing once a relatively high processing temperature has been reached. However, in the case of unstabilised polymers, appreciable decomposition of the polymers begins at such temperatures, such decomposition resulting both in the above-described undesired colour change and in modification of material properties. Furthermore, the hydrochloric acid released from unstabilised halogen-containing polymers at such a processing temperature may give rise to appreciable corrosion of processing equipment. This phenomenon is in particular of significance if, during the processing of such halogenated polymers into shaped articles, for example by extrusion, production is interrupted and the polymer composition stays in the extruder for an extended period. During this time, the above-stated decomposition reactions take place, so making the batch located in the extruder unusable and possibly damaging the extruder.

Furthermore, polymers which are subject to such decomposition have a tendency to form deposits in processing equipment which can then be removed only with difficulty.

In order to solve the stated problems, compounds which are intended to prevent the above-stated decomposition reactions to the greatest possible extent are added as “stabilisers” to halogen-containing polymers for the purposes of processing. In general, such stabilisers comprise solids which are added to the polymers to be processed prior to the processing thereof.

Apart from Pb and Sn compounds, it is primarily Ca/Zn compounds which are used as stabilisers. The use of Ca(OH)₂ as stabiliser has here in many cases proved to be particularly favourable. The reason for this is the elevated basicity of Ca(OH)₂, which, thanks to this property, is capable of binding the HCl released during processing and ageing and so preventing any further destruction of the halogen-containing polymer and in particular discoloration thereof.

The use of stabiliser compositions in the processing of halogen-containing polymers generally involves blending halogen-containing polymers and stabiliser compositions in such a manner that maximally intimate intermixing of stabiliser compositions and halogen-containing polymers is achieved. In the past, pulverulent stabiliser compositions have conventionally been used for this purpose. Stabiliser compositions which assume granular or pastille form are, however, also known and nevertheless permit a good dispersion in the halogen-containing polymer during processing. Fashioning stabiliser compositions in this manner for example provides the user with the advantage that such stabiliser compositions conventionally exhibit distinctly improved dusting behaviour during processing. Such improved dusting behaviour is, however, often accompanied by a reduction in the effort required to keep the air in the workplace clean, which in turn has a positive impact on costs.

The problem with using compositions fashioned in this manner is, however, that the production of corresponding stabiliser compositions is frequently associated with the action of heat. This means, however, that it is only possible to fashion those stabiliser compositions which, with regard to their composition, may be exposed to heat, without the efficacy of the stabiliser composition being impaired or at least no more than tolerably impaired due to decomposition phenomena.

Due to this issue, it has only been possible to fashion stabiliser compositions containing Ca(OH)₂ with difficulty, if at all, since, due to its elevated basicity, Ca(OH)₂ brings about the destruction of other constituents of the stabilisation melt at the temperatures of 130° C. and above which are conventional during processing.

The object of the present invention was therefore to provide a method for fashioning stabiliser melts, for example Ca/Zn melts, in particular for shaping them into pastilles, in which method stabiliser compositions are obtained, the further constituents of which are not modified or are at least no more than tolerably modified by the method with regard to external appearance or stabilising action or both. A further object of the invention was to provide a method which permits the production of stabiliser preparations having good handling properties. A further object of said method was also to permit the use of CaO or Ca(OH)₂ or a mixture thereof.

It has surprisingly now been found that these objects may be achieved by a method for fashioning melts, in particular for shaping melts into pastilles, in which the melt contains at most 10 wt. % of one or more polyols and at most 10 wt. % of one or more long-chain esters.

The present invention accordingly provides a method for fashioning melts containing CaO or Ca(OH)₂ or both, in which a melt containing CaO or Ca(OH)₂ or both and at least one organic compound or a mixture of two or more such compounds with a melting point or softening point of less than 200° C. is divided into portions and then cooled to obtain a melt-shaped article, wherein the melt contains at most 10 wt. % of one or more polyols and at most 10 wt. % of one or more long-chain esters.

For the purposes of the present invention, “fashioning” is taken to mean any kind of shaping, i.e. any procedure which is suitable for imparting a specific, substantially durable shape to a plastic article. This may proceed by a thermoplastic mass or a melt being placed in a mould and fixed therein in the resultant shape by cooling or leaving to cool, as is for example the case in injection moulding. Shaping may, however, also proceed by the thermoplastic mass or the melt being more or less finely dispersed and being fixed in the resultant shape on cooling; this is, for example, possible by using spray towers in which substantially spherical shapes are obtained. The shape of the thermoplastic mass or the melt may furthermore also be further modified after solidification, it being possible to obtain, for example, cylinders, cuboids, cubes, hexagons, pastilles and other shapes. Further shaping methods are moreover conceivable and are deemed to be a constituent part of the present invention.

For the purposes of the present invention, “melts containing CaO or Ca(OH)₂ or a mixture thereof” are taken to mean any kind of melts which contain CaO or Ca(OH)₂ or a mixture thereof and at least one organic compound with a melting point of less than 200° C.

It has surprisingly been found that, for the purposes of the present invention, stabiliser compositions for halogen-containing polymers containing CaO or Ca(OH)₂ or a mixture thereof may particularly readily be fashioned if they do not exceed a specific upper limit with regard to their content of polyols or long-chain esters.

For the purposes of the present invention, a “polyol” is taken to mean a compound which bears at least two alcoholic groups. The simplest such compounds are accordingly ethane-1,2-diol, propane-1,2-diol and propane-1,3-diol, butane-1,2-diol, butane-1,3-diol and butane-1,4-diol etc. It goes without saying that the compounds may also bear more than two alcoholic groups, such as propane-1,2,3-triol, butane-1,2,3-triol and butane-1,2,4-triol, wherein in this case too only the simplest representatives are stated, but this should not be interpreted to mean that the list is exhaustive, instead all further representatives of these groups are included. It is also immaterial whether the alcoholic groups are primary, secondary or tertiary. The carbon parent structuress (namely ethane, propane and butane in the examples listed) may moreover also be branched, wherein the branches may also bear alcoholic groups or the carbon parent structuress may be linked with one another via oxygen atoms. Non-limiting examples of the first group are 2-methylbutan-1-ol, 2-methylbutan-1,2-diol and 2-hydroxymethylbutan-1,4-ol, and of the second group ethylene glycol and propylene glycol.

A better illustration may be provided by stating some more polyols which fall within the above-stated definition and may conventionally be used in such melts: pentaerythritol, dipentaerythritol, tripentaerythritol, bistrimethylolpropane, inositol, polyvinyl alcohol, bistrimethylolethane, trimethylolpropane, sorbitol, maltitol, isomaltitol, lactitol, Lycasine, mannitol, lactose, leucrose, tris(hydroxymethyl)isocyanurate, palatinite, tetramethylolcyclohexanol, tetramethylolcyclopentanol, tetramethylolcycloheptanol, glycerol, diglycerol, polyglycerol, thiodiglycerol or 1-0-α-D-glycopyranosyl D-mannitol dihydrate.

For the purposes of the present invention, a “long-chain ester” is taken to mean an ester as may be obtained by reacting a suitable organic acid with a suitable alcohol in a manner known to a person skilled in the art, wherein at least one of the at least two carbon groups in the acid or alcohol comprises at least four carbon atoms. The at least two carbon groups in the acid or alcohol are here formed, on the one hand, by the parent substance of the corresponding acid and, on the other hand, by the parent substance of the corresponding alcohol. For example, at least one of these two main bodies comprises at least 6 carbon atoms or at least 12 carbon atoms or at least 18 carbon atoms.

For the purposes of a further embodiment of the present invention, both carbon groups in each case comprise for example at least 4, for example at least 6 or at least 12 or at least 18 carbon atoms. Non-exhaustive examples of such esters are accordingly those which may be obtained, for example, from the reaction of saturated alcohols, such as ethyl, propyl, butyl, pentyl, hexyl, heptyl, octyl, nonyl, decyl, cetyl, ceryl and myricyl alcohol or of unsaturated alcohols, such as vinyl, allyl and propargyl alcohol with saturated acids, such as formic, acetic, propionic, butyric, valeric, caproic, caprylic, capric, lauric, oenanthic, octanoic, neodecanoic, 2-ethylhexanoic, pelargonic, decanoic, undecanoic, dodecanoic, tridecanoic, myristyl, palmitic, stearic, behenic, 3,6-dioxaheptanoic and 3,6,9-trioxadecanoic acid, or with unsaturated acids, such as acrylic, methacrylic, crotonic, isocrotonic, vinylacetic, oleic, elaidic and propiolic acid, or with aromatic acids, such as benzoic, p-tert-butylbenzoic, toluoylic, dimethylbenzoic, ethylbenzoic, n-propylbenzoic, salicylic, p-tert-octylsalicylic, sorbic acid, or with divalent carboxylic acids, such as oxalic, malonic, maleic, tartaric, cinnamic, mandelic, malic, glycolic and polyglycolic dicarboxylic acids with a degree of polymerisation of approx. 10 to approx. 12, phthalic, isophthalic, terephthalic or hydroxyphthalic acid, or with tri- or tetravalent carboxylic acids, such as hemimellitic, trimellitic and pyromellitic acid, subject to the condition that an acid and an alcohol, both of which comprise fewer than four carbon atoms, are not combined with one another. Although this is only a non-exhaustive list provided by way of illustration, it should be noted that in each case all conceivable forms of the acids or alcohols may be present alone or as a mixture, “valeric acid” for example denoting not only n-valeric acid, but also isovaleric acid, ethylmethylacetic acid and trimethylacetic acid.

A method as described above is for example suitable if the stabiliser melt contains one or more polyols or one or more long-chain esters mutually independently in a quantity of no more than 1 wt. %, for example in a quantity of no more than 0.1 wt. %. For the purposes of a method according to the invention, the stabiliser melt is preferably substantially free of polyols or of long-chain esters or of both.

For the purposes of the method according to the invention for fashioning stabiliser compositions, a melt is produced which contains at least CaO or Ca(OH)₂ or both and at least one organic compound with a melting point of less than 200° C.

A suitable organic compound with a melting point of less than 200° C. is in principle any desired organic compound which, on the one hand, is suitable for producing a melt which may be fashioned and, on the other hand, as a constituent of a stabiliser composition for stabilising halogen-containing polymers, at least exhibits no properties which are disadvantageous or are more than avoidably disadvantageous. Such an organic compound with a melting point of less than 200° C. is preferably inert or at least substantially inert towards further compounds present in such a melt, in particular towards CaO or Ca(OH)₂ or both.

Suitable organic compounds with a melting point of less than 200° C. which may be considered are in particular metal soaps of saturated, unsaturated, linear or branched, aromatic, cycloaliphatic or aliphatic carboxylic acids with preferably approx. 2 to approx. 44 C atoms. With regard to suitable carboxylic acids, reference is made to the non-exhaustive list of carboxylic acids stated above in the definition of the “long-chain esters”.

Among saturated, unsaturated, linear or branched, aromatic, cycloaliphatic or aliphatic carboxylic acids with preferably approx. 2 to approx. 44 C atoms, it is the saturated carboxylic acids which have proved highly suitable. For example, saturated linear carboxylic acids with approx. 6 to approx. 28, for example approx. 12 to approx. 24 or approx. 14 to approx. 20 carbon atoms, for example with approx. 14, 16 or 18 carbon atoms are suitable.

For the purposes of further embodiment of the present invention, organic compounds with a melting point of less than 200° C. which are preferably used are metal soaps whose anions are derived from saturated or unsaturated carboxylic acids or hydroxycarboxylic acids with approx. 8 to approx. 20 C atoms. Stearates, oleates, laurates, palmitates, behenates, versatates, p-tert-butylbenzoates or (iso)octanoates or mixtures of two or more thereof are particularly preferred.

The metal oxides, metal hydroxides or metal soaps suitable as additives preferably comprise as metal cations a divalent cation, with the cations of magnesium, barium, aluminium, calcium or zinc or mixtures thereof, in particular the cations of calcium or zinc and mixtures thereof, being particularly suitable.

Paraffin waxes, polyethylene waxes, amide waxes, chlorinated paraffins or compounds designated slip agents, as are described, for example, in “Kunststoffadditive” [Plastics additives], R. Gächter/H. Müller, Carl Hanser Verlag, 3rd edition, 1989, pages 478-488 are for example likewise suitable as organic compounds with a melting point of less than 200° C. Fatty ketones, as described in DE 4,204,887, are for example furthermore suitable as organic compounds with a melting point of less than 200° C. Reference is hereby specifically made to the stated documents, the disclosure of which relating to slip agents being deemed to be a constituent part of the disclosure of the present document. Further suitable organic compounds are chlorinated hydrocarbons (paraffins) or hydrocarbons as are described in “Kunststoffadditive” [Plastics additives], R. Gächter/H. Müller, Carl Hanser Verlag, 3rd edition, 1989, section 5.9.14.2, pages 422-425 and section 5.9.14.1, page 422. Extremely small quantities of ester-based slip agents such as stearyl stearate, distearyl phthalate and the like, as are described in “Kunststoffadditive” [Plastics additives], R. Gächter/H. Müller, Carl Hanser Verlag, 3rd edition, 1989, are likewise suitable as organic compounds with a melting point of less than 200° C., provided that said slip agents have no negative effect on the object of the invention.

For the purposes of a further embodiment of the present invention, the stabiliser melt contains calcium stearate or zinc stearate or a mixture thereof as a mixture of two or more organic compounds with a melting point of less than 200° C.

A melt usable for the purposes of the present invention has a content of organic compound with a melting point or softening point of less than 200° C. and CaO or Ca(OH)₂ or both of in total approx. 0.1 to approx. 100 wt. %, relative to the entire melt. For example, a melt usable for the purposes of the present invention has a content of organic compound with a melting point or softening point of less than 200° C. and CaO or Ca(OH)₂ or both of approx. 1 to approx. 100 or approx. 5 to approx. 99 or approx. 10 to approx 90. or approx. 20 to approx. 85 or approx. 30 to approx. 80 or approx. 40 to approx. 70 or approx. 50 to approx. 60 wt. %.

Relative to the proportion of organic compound with a melting point or softening point of less than 200° C. and CaO or Ca(OH)₂ or both in the melt, the proportion of CaO or Ca(OH)₂ or both is selected such that the melt may be fashioned for the purposes of the method according to the invention. For example, the proportion of CaO or Ca(OH)₂ or both amounts to approx. 0.1 to approx. 80 wt. % or approx. 1 to approx. 60 wt. % or approx. 2 to approx. 40 wt. %.

For the purposes of a method according to the invention for producing stabiliser melts which may be fashioned, the melt may in principle be produced in any desired manner. Accordingly, all the constituents of the melt may, for example, initially be introduced into an appropriate apparatus, whereupon heat is introduced in suitable manner and the initially introduced amount is thus caused to melt. However, it is also possible for the purposes of the present invention for example initially to introduce the fusible constituents of the melt, to melt them and then to add the constituents which do not melt at the melt temperature.

The method according to the invention may be carried out as a batch method or as a continuous method. If the method process is carried out as a batch method, it may in principle be carried out in any desired, for example heatable, tanks which are preferably equipped with a stirrer. Heating means which may be considered are in principle any possible means with which the contents of a corresponding tank may be heated in such a manner that the contents forms a corresponding melt.

If the method according to the invention is to be carried out continuously, any apparatus which permits the method according to the invention to be carried out continuously is in principle suitable for this purpose. Such apparatus comprises for example loop reactors and the like.

The stabiliser melt may furthermore additionally comprise a plurality of further compounds as additives which serve various functions in the melt or in the product. The additives stated below may in principle be used for the purposes of a melt according to the invention. However, for example depending on the melt's content of CaO or Ca(OH)₂ or both, it is possible for certain of the additives stated below to be usable only up to a certain melt content of CaO or Ca(OH)₂ or both. This situation may, however, straightforwardly be checked without unreasonable effort by a person skilled in the art by introducing a specific additive into melts with different contents of CaO or Ca(OH)₂ or both and checking the behaviour thereof with regard to any decomposition which may occur in the melt.

These are, for example, the aminouracil compounds of the general formula I

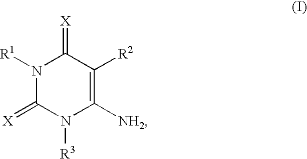

in which the residues R¹ and R² in each case mutually independently denote hydrogen, an optionally substituted linear or branched, saturated or unsaturated aliphatic alkyl residue with 1 to 44 C atoms, an optionally substituted saturated or unsaturated cycloalkyl residue with 6 to 44 C atoms or an optionally substituted aryl residue with 6 to 44 C atoms or an optionally substituted aralkyl residue with 7 to 44 C atoms or the residue R¹ denotes an optionally substituted acyl residue with 2 to 44 C atoms and the residue R³ denotes hydrogen, an optionally substituted linear or branched, saturated or unsaturated aliphatic hydrocarbon residue with 1 to 44 C atoms, an optionally substituted saturated or unsaturated cycloaliphatic hydrocarbon residue with 6 to 44 C atoms or an optionally substituted aromatic hydrocarbon residue with 6 to 44 C atoms.

Suitable additives are furthermore in general those compounds with a structural element of the general formula II

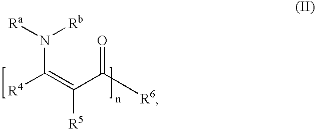

in which n denotes a number from 1 to 100,000, the residues R^{a}, R^{b}, R⁴ and R⁵ in each case mutually independently denote hydrogen, an optionally substituted linear or branched, saturated or unsaturated aliphatic alkyl residue with 1 to 44 C atoms, an optionally substituted saturated or unsaturated cycloalkyl residue with 6 to 44 C atoms or an optionally substituted aryl residue with 6 to 44 C atoms or an optionally substituted aralkyl residue with 7 to 44 C atoms or the residue R⁴ denotes an optionally substituted acyl residue with 2 to 44 C atoms or the residues R^{e} and R⁵ are joined to form an aromatic or heterocyclic system and in which the residue R⁶ denotes hydrogen, an optionally substituted, linear or branched, saturated or unsaturated aliphatic alkyl or alkylene residue or oxyalkyl or oxyalkylene residue or mercaptoalkyl or mercaptoalkylene residue or aminoalkyl or aminoalkylene residue with 4 or 5 or 6 to 44 C atoms, an optionally substituted saturated or unsaturated cycloalkyl or cycloalkylene residue or oxycycloalkyl or oxycycloalkylene residue or mercaptocycloalkyl or mercaptocycloalkylene residue or aminocycloalkyl or aminocycloalkylene residue with 6 to 44 C atoms or an optionally substituted aryl or arylene residue with 6 to 44 C atoms or an ether or thioether residue with 1 to 20 O or S atoms or O and S atoms or denotes a polymer which is joined at n positions via O, S, NH, NR^{a} or CH₂C(O) to the structural element located between brackets or the residue R⁶ is joined to the residue R⁴ in such a manner that overall an optionally substituted, saturated or unsaturated heterocyclic ring system with 4 to 24 C atoms is formed.

The stated compounds may be present in a stabiliser melt according to the invention in each case alone or as mixture of two or more thereof.

Further suitable additives are for example compounds which comprise a mercapto-functional sp²-hybridised C atom, carbazoles, carbazole derivatives or 2,4-pyrrolidinedione or 2,4-pyrrolidinedione derivatives.

Compounds comprising at least one mercapto-functional, sp²-hybridised C atom which are suitable for the purposes of the present invention are in principle any compounds which comprise a structural element Z=CZ-SH or a structural element Z₂C═S, wherein both structural elements may be tautomeric forms of a single compound. Z here denotes any desired residues which, together with the structure C═S, form a compound with at least one sp²-hybridised C atom. Z may for example denote linear, branched, saturated or unsaturated, aliphatic or aromatic or cyclic structures. The sp²-hybridised C atom may here be a constituent of an optionally substituted aliphatic compound or a constituent of an aromatic system. Suitable types of compounds are for example thiocarbamic acid derivatives, thiocarbamates, thiocarboxylic acids, thiobenzoic acid derivatives, thioacetone derivatives or thiourea or thiourea derivatives.

Epoxy compounds are, for example, likewise suitable as additives. Examples of such epoxy compounds are epoxidised soya oil, epoxidised olive oil, epoxidised linseed oil, epoxidised castor oil, epoxidised peanut oil, epoxidised corn oil, epoxidised cottonseed oil and glycidyl compounds.

Particularly suitable epoxy compounds are for example described on pages 3 to 5 of EP-A 1 046 668, reference explicitly being made to the disclosure contained therein and the disclosure being deemed to be a constituent part of the disclosure of the present document.

1,3-Dicarbonyl compounds, in particular β-diketones and β-keto esters, are furthermore suitable as additives for the purposes of the present invention. Dicarbonyl compounds which are suitable for the purposes of the present invention are those of the general formula R′C(O)CHR″-C(O)R′″, as are for example described on page 5 of EP-1 046 668, to which explicit reference is made with regard to the residues R′, R″ and R′″ and the disclosure of which is deemed to be a constituent part of the disclosure of the present document. Particularly suitable in this connection are, for example, acetylacetone, butanoylacetone, heptanoylacetone, stearoylacetone, palmitoylacetone, lauroylacetone, 7-tert-nonylthioheptane-2,4-dione, benzoylacetone, dibenzoylmethane, lauroylbenzoylmethane, palmitoylbenzoylmethane, stearoylbenzoylmethane, isooctylbenzoylmethane, tribenzoylmethane, bis(4-methylbenzoyl)methane, benzoyl-p-chlorbenzoylmethane, benzoylformylmethane, benzoylacetylphenylmethane, 1-benzoyl-1-acetylnonane, stearoyl-4-methoxybenzoylmethane, bis(4-tert-butylbenzoyl)methane, benzoylphenylacetylmethane, bis(cyclohexanoyl)methane, dipivaloylmethane, 2-acetylcyclopentanone, 2-benzoylcyclopentanone.

1,3-Diketo compounds may be present in a stabiliser melt according to the invention in a quantity from 0 up to approx. 20 wt. %, for example approx. 0.1 up to approx. 10 wt. %.

Sterically hindered amines, as are stated on pages 7 to 27 of EP-A 1 046 668, are, for example, likewise suitable as additives. Reference is explicitly made to the sterically hindered amines disclosed therein, the compounds stated therein being deemed to be a constituent part of the disclosure of the present document.

The sterically hindered amines suitable as additives may be present in a stabiliser melt according to the invention in a quantity of up to approx. 30 wt. %, for example up to approx. 10 wt. %.

A stabiliser melt according to the invention may furthermore contain an organotin compound or a mixture of two or more organotin compounds as an additive. Suitable organotin compounds are for example methyltin tris(isooctylthioglycolate), methyltin tris(isooctyl-3-mercaptopropionate), methyltin tris(isodecylthioglycolate), dimethyltin bis(isooctylthioglycolate), dibutyltin bis(isooctylthioglycolate), monobutyltin tris(isooctylthioglycolate), dioctyltin bis(isooctylthioglycolate), monooctyltin tris(isooctylthioglycolate) or dimethyltin bis(2-ethylhexyl-p-mercaptopropionate).

The organotin compounds stated and described with regard to their production on pages 18 to 29 of EP-A 0 742 259 are furthermore usable for the purposes of the stabiliser melt according to the invention. Reference is explicitly made to the above-stated disclosure, the compounds stated therein and the production thereof being taken to be a constituent part of the disclosure of the present document.

A stabiliser melt according to the invention may contain the described organotin compound in a quantity of 0 up to approx. 40 wt. %, in particular approx. 0.1 to approx 20 wt. %.

For the purposes of a further embodiment of the present invention, a stabiliser melt according to the invention may contain organic phosphite esters with 1 to 3 identical, pairwise identical or different organic residues. Suitable organic residues are for example linear or branched, saturated or unsaturated alkyl residues with 1 to 24 C atoms, optionally substituted alkyl residues with 6 to 20 C atoms or optionally substituted aralkyl residues with 7 to 20 C atoms. Examples of suitable organic phosphite esters are tris(nonylphenyl), trilauryl, tributyl, trioctyl, tridecanyl, tridodecyl, triphenyl, octyldiphenyl, dioctylphenyl, tri(octylphenyl), tribenzyl, butyl dicresyl, octyldi(octylphenyl), tris(2-ethylhexyl), tritolyl, tris(2-cyclohexylphenyl), tri-α-naphthyl, tris(phenylphenyl), tris(2-phenylethyl), tris(dimethylphenyl), tricresyl or tris(p-nonylphenyl) phosphite or tristearyl sorbitol triphosphite or mixtures of two or more thereof.

A stabiliser melt according to the invention may contain the described phosphite compounds in a quantity of 0 up to approx. 30 wt. %, in particular approx. 0.1 to approx. 10 wt. %.

A stabiliser melt according to the invention may furthermore contain blocked mercaptans, as are stated on pages 4 to 18 of EP-A 0 742 259, as additives.

Reference is explicitly made to the disclosure in the stated document which is taken to be a constituent part of the present disclosure.

A stabiliser melt according to the invention may contain the described blocked mercaptans in a quantity of 0 up to approx. 30 wt. %, in particular approx. 0.1 up to approx. 10 wt. %.

Organic plasticisers are likewise suitable as additives for stabiliser melts according to the present invention.

Suitable corresponding plasticisers are, for example, phosphoric acid esters, as may be found in “Taschenbuch der Kunststoffadditive” [Handbook of plastics additives], section 5.9.5, pages 408-412. Examples of suitable phosphoric acid esters are tributyl phosphate, tri-2-ethylbutyl phosphate, tri-2-ethylhexyl phosphate, trichloroethyl phosphate, 2-ethylhexyldiphenyl phosphate, triphenyl phosphate, tricresyl phosphate or trixylenyl phosphate, or mixtures of two or more thereof.

For the purposes of a further embodiment of the present invention, the stabiliser melts according to the invention may contain antioxidants, UV absorbers or light stabilisers. Suitable antioxidants are described, for example, on pages 33 to 35 of EP-A 1 046 668. Suitable UV absorbers and light stabilisers are stated therein on pages 35 and 36. Explicit reference is here made to both disclosures, the disclosures being deemed to be a constituent part of the present document.

A stabiliser melt according to the invention may furthermore contain fillers, as are described in “Handbook of PVC Formulating”, E. J. Wickson, John Wiley & Sons Inc., 1993, on pages 393-449 or reinforcing materials, as are described in “Taschenbuch der Kunststoffadditive” [Handbook of plastics additives], R. Gächter/H. Müller, Carl Hanser Verlag, 1990, pages 549-615, or pigments.

Hydrotalcites, hydrocalumites, zeolites and alkali metal alumino carbonates are furthermore suitable as additives in the stabiliser melts according to the invention or in the stabiliser shaped articles according to the invention. Suitable hydrotalcites, hydrocalumites, zeolites and alkali metal alumino carbonates are described, for example, on pages 27 to 29 of EP-A 1 046 668, on pages 3, 5 and 7 of EP-A 256 872, on pages 2 and 3 of DE-C 41 06 411 or on pages 2 and 3 of DE-C 41 06 404 or in DE-C 198 60 798. Reference is explicitly made to these documents and the disclosure thereof is deemed to be a constituent part of the disclosure of the present document.

A stabiliser melt according to the invention may furthermore additionally contain impact modifiers and processing aids, gelling agents, antistatic agents, biocides, metal deactivators, optical brighteners, flame retardants and antifogging compounds. Suitable compounds from these classes are described, for example, in “Kunststoffadditive” [Plastics additives], R. Keβler/H. Müller, Carl Hanser Verlag, 3rd edition, 1989 and in the “Handbook of PVC Formulating”, E. J. Wilson, J. Wiley & Sons, 1993.

The invention moreover relates to a fashioning method, as described above, in which a stabiliser shaped article is obtained as product.

These shaped articles may in principle be of any desired form. Suitable shapes are for example pastilles, flakes, spheres, cylinders and the like.

Such shapes may be produced by known shaping methods, for example by placing a thermoplastic mass in a mould and fixing it therein in the resultant shape by cooling or leaving to cool, as is for example the case in injection moulding. Shaping may, however, also proceed by the thermoplastic mass being more or less finely dispersed and being fixed in the resultant shape on cooling; this is, for example, possible by using spray towers in which substantially spherical shapes are obtained. It is furthermore also possible further to modify the shape of the thermoplastic mass during cooling, for example by flaking. Pastille shaping methods, as may be carried out by Rotoformer (from Sandvik) or Rollomat (from Kaiser) units, are likewise suitable.

A method known as “drop pelletisation” is likewise also suitable. In this method, the stabiliser melt is shaped into drops with the assistance of a perforated, vibrating plate. The plate here vibrates in the direction of the line normal to the plate, wherein, depending on the viscosity the melt and frequency of vibration, particularly regularly shaped drops with a narrow size distribution may be obtained.

The Mino-proppo-line from Rieter Automatik GmbH in Grossostheim (Germany) is, for example, suitable for carrying out this method. For example, a frequency of vibration of approx. 100-500 Hz, for example approx. 250 to approx. 400 Hz, a nozzle diameter of approx. 200 to 600 μm, in particular a nozzle diameter of approx. 250 to approx. 400 μm, a pressure (depending on the viscosity of the melt) of approx. 0.4 to approx. 5 bar, and a nozzle temperature in a range of approx. −10 to approx +10° C. around the melting point of the melt are used.

For the purposes of a further preferred embodiment of the present invention, the drops are cooled before coming into contact with a collecting device.

In order to ensure that the resultant shaped articles have good handling properties during their subsequent use, thus for example that they exhibit good conveying characteristics, preferred shapes are those which permit good pouring and/or conveying using reduced or elevated pressure or combinations of the two. Spherical or pastille shapes are here particularly preferred.

The present invention also provides a method, as described above, in which the constituents to be shaped into pastilles are placed in a vessel, are melted with the assistance of heating means and stabiliser shaped articles are produced from this stabiliser melt.

Temperatures of more than 100° C., preferably more than 110° C., particularly preferably more than 120° C., such as 130° C., 140° C. or 150° C. are achieved during melting. This may be achieved by using conventional heating means, thus for example not only by electrical heating, by heating with a flame, steam or oil or by irradiation with electromagnetic waves, such as microwaves, induction heating but also by combining different constituents which react exothermically with one another in the stabiliser melt and, in so doing, form a desired or at least non-disruptive stabiliser melt constituent.

The present invention also provides a stabiliser melt which contains polyols and long-chain esters in the above-stated quantities, and a fashioned stabiliser shaped article which may be produced in accordance with the above-described method.

The present invention further provides the use of a stabiliser melt, as described above, or of stabiliser shaped articles, as described above, in the production of polymeric mouldings or surface coating compositions.

The shaped articles according to the invention may be blended with one or more polymers which have to be stabilised in order not to exhibit any unwanted changes over long-term service and in particular during processing. Halogen-containing organic polymers in particular require such stabilisation.

Examples of such halogen-containing organic polymers are polymers of vinyl chloride, vinyl resins which contain vinyl chloride units in the polymer backbone, copolymers of vinyl chloride and vinyl esters of aliphatic acids, in particular vinyl acetate, copolymers of vinyl chloride with esters of acrylic and methacrylic acid or acrylonitrile or mixtures of two or more thereof, copolymers of vinyl chloride with diene compounds or unsaturated dicarboxylic acids or the anhydrides thereof, for example copolymers of vinyl chloride with diethyl maleate, diethyl fumarate or maleic anhydride, post-chlorinated polymers and copolymers of vinyl chloride, copolymers of vinyl chloride and vinylidene chloride with unsaturated aldehydes, ketones and other compounds such as acrolein, crotonaldehyde, vinyl methyl ketone, vinyl methyl ether, vinyl isobutyl ether and the like, polymers and copolymers of vinylidene chloride with vinyl chloride and other polymerisable compounds, polymers of vinyl chloroacetate and dichlorodivinyl ether, chlorinated polymers of vinyl acetate, chlorinated polymeric esters of acrylic acid and α-substituted acrylic acids, chlorinated polystyrenes, for example polydichlorostyrene, chlorinated polymers of ethylene, polymers and post-chlorinated polymers of chlorobutadiene and the copolymers thereof with vinyl chloride and blends of two or more of the stated polymers or polymer blends which contain one or more the above-stated polymers.

Graft polymers of PVC with EVA, ABS or MBS are likewise suitable for stabilisation with the stabiliser melts according to the invention and/or the stabiliser shaped articles according to the invention. Preferred substrates for such graft copolymers are moreover the above-stated homo- and copolymers, in particular blends of vinyl chloride homopolymers with other thermoplastic or elastomeric polymers, in particular blends with ABS, MBS, NBR, SAN, EVA, CPE, MBAS, PAA (polyalkyl acrylate), PAMA (polyalkyl methacrylate), EPDM, polyamides or polylactones.

Mixtures of halogenated and non-halogenated polymers, for example mixtures of the above-stated non-halogenated polymers with PVC, in particular mixtures of polyurethanes and PVC are likewise suitable for stabilisation with the stabiliser shaped articles obtainable from the stabiliser melts according to the invention.

Recycled chlorine-containing polymers, wherein in principle any recycled materials of the above-stated, halogenated polymers are suitable for this purpose, may furthermore be stabilised with the stabiliser melts according to the invention and/or the stabiliser shaped articles according to the invention. PVC recycled material, for example, is suitable for the purposes of the present invention.

In addition to this use of the stabiliser melts according to the invention and/or the stabiliser shaped articles according to the invention, the present invention also provides a method for stabilising halogen-containing polymers, in which a halogen-containing polymer or a mixture of two or more halogen-containing polymers or a mixture of one or more halogen-containing polymers and one or more halogen-free polymers is blended with at least one stabiliser shaped article according to the invention.

The polymer or polymers may be blended with the stabiliser melt according to the invention or with stabiliser shaped articles according to the invention in principle at any desired time before or during processing of the polymer(s). The stabiliser shaped articles may thus, for example, be incorporated into the polymer in powder or granule form prior to processing. It is, however, likewise possible to add the stabiliser shaped articles to the polymer or polymers in the softened or molten state, for example during processing in an extruder.

The present invention further provides a polymer composition which at least contains a halogen-containing, organic polymer and the stabilisation constituents used in a method as described above or the stabilisation constituents of the stabiliser melt according to the invention or the stabilisation constituents of a stabiliser shaped article according to the invention.

For the purposes of a preferred embodiment of the present invention, a polymer composition according to the invention contains the constituents of the stabiliser melt according to the invention or the stabiliser shaped articles according to the invention in a quantity of 0.1 to 20 phr, in particular approx. 0.5 to approx. 15 phr or approx. 1 to approx. 12 phr. Values of at least 0.3 phr, such as at least approx. 0.4 or at least approx. 0.75 phr are here preferred. The unit phr means “per hundred resin” and so relates to parts by weight per 100 parts by weight of polymer.

A polymer composition according to the invention preferably contains as halogenated polymer at least in part PVC, wherein the proportion of PVC in particular amounts to at least approx. 20, preferably at least approx. 50 wt. %, for example at least approx. 80 or at least approx. 90 wt. %.

A particularly preferred polymer composition is accordingly one which contains the stabilisation constituents, thus the constituents of the stabiliser melt according to the invention or the stabiliser shaped articles according to the invention, in a quantity of 0.1 to approx. 30 wt. %.

The present invention also provides a shaped article which contains a polymer composition according to the invention.

A polymer composition according to the invention may be converted into a desired shape in known manner. Suitable methods are for example calendering, extrusion, injection moulding, sintering, extrusion-blowing or the plastisol method. A polymer composition according to the invention may, for example, also be used for the production of foams. The polymer compositions according to the invention are in principle suitable for the production of unplasticised or in particular plasticised PVC.

For the purposes of the present invention, the term “shaped article” in principle includes any three-dimensional structure which can be produced from a polymer composition according to the invention.

For the purposes of the present invention, the term “shaped article” for example comprises wire sheathing, automotive parts, for example automotive parts as used in automotive interiors, in the engine compartment or on exterior surfaces, cable insulation, decorative films, agricultural films, hoses, seal profiles, office films, hollow articles (bottles), packaging film (thermoforming films), blown films, tubes, foams, heavy profiles (window frames), illuminated wall profiles, building profiles, sidings, fittings, sheets, foam sheets, coextrudates with a recycled core or housings for electrical equipment or machinery, for example computers or domestic appliances. Further examples of shaped articles which may be produced from a polymer composition according to the invention are artificial leather, floor coverings, textile coatings, wall coverings, coil-coating compositions or underbody sealants for motor vehicles.

The following Examples illustrate the present invention in greater detail:

### EXAMPLES

The following formulations were produced by the melt method. The fusible constituents (paraffin wax, zinc stearate) were here initially introduced and melted and the further formulation ingredients were gradually added. Once addition was complete, the finished suspension was applied onto a metal sheet to cool and solidify. Once solidified, the mass was comminuted in a conventional commercial kitchen blender.

TABLE 1
Formulations:

| Constituent | No. 1 | No. 2 |
|---|---|---|
| Paraffin wax | 32.5 | 32.5 |
| Zinc stearate | 30 | 30 |
| Calcium stearate | 20 | 20 |
| Zeolite | 15 | 15 |
| Calcium hydroxide | 12.5 | 12.5 |
| Pentaerythritol | | 10 |

The finished stabiliser blends were then converted into a PVC dry blend:

TABLE 2
Dry blend formulations:

| Constituent | Dry blend no. 1 | Dry blend no. 2 |
|---|---|---|
| PVC (K value 68) | 100 | 100 |
| Chalk | 4 phr | 4 phr |
| Formulation no. 1 | 2.2 phr | |
| Formulation no. 2 | | 2.4 phr |

0.2 phr more of formulation no. 2 was used in order to maintain a constant quantity of slip agent.

The dry blends were extruded in a Göttfert single screw laboratory extruder.

TABLE 3
Extrusion values

| | Dry blend no. 1 | Dry blend no. 2 |
|---|---|---|
| Pressure at 9D [bar] | 52.2 | 81.5 |
| Pressure at 14D [bar] | 67.6 | 213.6 |
| Pressure at 20D [bar] | 74.2 | 136.2 |
| Torque [Nm] | 83.1 | 128.6 |
| Back force [kN] | 6.0 | 10.6 |

Comparison of the measurement results clearly shows that extrusion with dry blend no. 2 exposes the material and the extruder to substantially higher loads.

The colour of the extruded tapes was investigated using the Lab system.

TABLE 4
Colour investigation

| | Tape made from dry blend | Tape made from dry blend |
|---|---|---|
| | no. 1 | no. 2 |
| L value | 69.2 | 66.0 |
| a value | 1.7 | 2.5 |
| b value | 15.2 | 21.7 |

The values show that the tape made from dry blend no. 2 is distinctly darker and exhibits a yellow discoloration relative to the tape made from dry blend no. 1.

1. A method for fashioning melts containing CaO, Ca(OH)₂ or mixtures thereof, comprising:
dividing a melt containing CaO, Ca(OH)₂ or mixtures thereof and at least one organic compound having a melting point or softening point of less than 200° C. into portions; and
cooling the melt to obtain a melt-shaped article,
wherein the melt contains at most 10 wt. % of one or more polyols and at most 10 wt. % of one or more long-chain esters, wherein the at least one organic compound having a melting point or softening point of less than 200° C. is substantially inert towards the CaO, Ca(OH)₂ or mixtures thereof, and wherein the melt includes calcium stearate, zinc stearate or mixtures thereof.

2. A method according to claim 1, wherein the melt contains at least one zinc compound.

3. A method according to claim 1, wherein the melt contains less than 1 wt. % of polyols or less than 1 wt. % of esters.

4. A method according to claim 1, wherein the melt contains less than 0.1 wt. % of polyols or less than 0.1 wt. % of esters.

5. A method according to claim 1, in which the melt-shaped article substantially comprises pastilles, flakes, spheres or cylinders.

6. A method according to claim 1, wherein the constituents to be fashioned are placed in a vessel, are melted and melt-shaped articles are produced from said melt.

7. A melt comprising CaO, Ca(OH)₂ or mixtures thereof and at least one organic compound with a melting point of less than 200° C., wherein the melt contains at most 10 wt. % of one or more long-chain esters.

8. A melt-shaped article comprising CaO, Ca(OH)₂ or mixtures thereof and at least one organic compound with a melting point of less than 200° C., wherein the melt-shaped article contains at most 10 wt. % of one or more polyols and at most 10 wt. % of one or more long-chain esters, wherein the at least one organic compound with a melting point of less than 200° C. is substantially inert towards CaO, Ca(OH)₂ or mixtures thereof, and wherein the melt-shaped article includes calcium stearate, zinc stearate, or a mixture thereof.

9. A polymer composition produced by blending a halogen-containing organic polymer with a melt-shaped article according to claim 8.

10. (canceled)

11. A method for stabilising a halogen-containing polymer, comprising blending a one or more halogen-containing polymers and optionally one or more halogen-free polymers with a melt-shaped article according to claim 8.

12. A method according to claim 3, wherein the melt contains less than 1 wt. % of polyols and less than 1 wt. % of esters.

13. A method according to claim 4, wherein the melt contains less than 0.1 wt. % of polyols and less than 0.1 wt. % of esters.

14. A polymer composition produced by blending a halogen-containing organic polymer with a melt-shaped article produced according to claim 1.

15. A method for stabilising a halogen-containing polymer, comprising blending one or more halogen-containing polymers and optionally one or more halogen-free polymers with a melt-shaped article produced according to claim 1.
